(19) United States
(12) Patent Application Publication
(10) Pub. No.: US 2022/0335111 A1
(43) Pub. Date: Oct. 20, 2022

(54) PROCESSING MANAGEMENT SYSTEM, PROCESSING MANAGEMENT APPARATUS, PROCESSING MANAGEMENT METHOD, AND COMPUTER PROGRAM

(71) Applicant: NEC Corporation, Minato-ku, Tokyo (JP)

(72) Inventor: Jeongwon Lee, Tokyo (JP)

(73) Assignee: NEC Corporation, Minato-ku, Tokyo (JP)

(21) Appl. No.: 17/626,599

(22) PCT Filed: Mar. 17, 2019
(86) PCT No.: PCT/JP2020/011801

§ 371 Date: Jan. 12, 2022

(30) Foreign Application Priority Data
Jul. 16, 2019 (JP) 2019-130988

(51) Int. Cl. G06F 21/32

(52) U.S. Cl. CPC G06F 21/32

(57) ABSTRACT

A processing management system includes: a first acquisition unit that obtains a first information, which is to be used for a predetermined process in a facility, from a clothing ornament of a user who uses the facility; a second acquisition unit that obtains a second information, which is to be used in an authentication process for the user, in a different path from that of the first information; an authentication unit that performs the authentication process by using the second information; and a permission unit that permits execution of the predetermined process using the first information, when the user can be authenticated in the authentication process. According to such a processing management system, it is possible to suitably manage whether or not to permit the execution of the process performed in the facility.

### TECHNICAL FIELD

The present invention relates to a processing management system, a processing management apparatus, a processing management method, and a computer programs that manage a process performed in a facility.

### BACKGROUND ART

A known system of this type is configured to read information from decorative items that a user wears, thereby to perform various processes, such as payment or settlement. For example, Patent Literatures 1 to 5 disclose a technique/technology in which an artificial nail is equipped with an IC tag or the like, from which information is read to perform various processes.

### CITATION LIST

### Patent Literature

Patent Literature 1: JP2018-524677A
Patent Literature 2: International Publication No. WO2017/098974
Patent Literature 3: JP2008-046922A
Patent Literature 4: JP2016-126792A
Patent Literature 5: JP2006-040109A

### SUMMARY

### Technical Problem

In the technique/technology as described in the above Patent Literatures 1 to 5, for example, when the artificial nail is lost, there is a risk that it is illegally utilized by a third party who found it. Specifically, an owner of the artificial nail may receive damage by spoofing, such as the artificial nail is used to purchase expensive goods without the owner's knowledge. As described above, there is room for improvement in security in the technique/technology described in each of the above Patent Literatures.

In view of the problems described above, it is therefore an example object of the present invention to provide a processing management system, a processing management apparatus, a processing management method, and a computer program that are configured to suitably manage whether or not to permit the execution of the process performed in a facility.

### Solution to Problem

A processing management system according to an example aspect of the present invention includes: a first acquisition unit that obtains a first information, which is to be used for a predetermined process in a facility, from a clothing ornament of a user who uses the facility; a second acquisition unit that obtains a second information, which is to be used in an authentication process for the user, in a different path from that of the first information; an authentication unit that performs the authentication process by using the second information; and a permission unit that permits execution of the predetermined process using the first information, when the user can be authenticated in the authentication process.

A processing management apparatus according to an example aspect of the present invention is a processing management apparatus that is configured to determine whether or not to permit execution of a predetermined process in a facility using a first information, which is obtained from a clothing ornament of a user who uses the facility, the processing management apparatus including: an authentication unit that performs an authentication process for the user, by using a second information, which is obtained in a different path from that of the first information; and a permission unit that permits the execution of the predetermined process using the first information, when the user can be authenticated by the authentication unit.

A processing management method according to an example aspect of the present invention includes: a first acquisition step that obtains a first information, which is to be used for a predetermined process in a facility, from a clothing ornament of a user who uses the facility; a second acquisition process that obtains a second information, which is to be used in an authentication process for the user, in a different path from that of the first information; an authentication process that performs the authentication process by using the second information; and a permission process that permits execution of the predetermined process using the first information, when the user can be authenticated in the authentication process.

A computer program according to an example aspect of the present invention allows a computer to execute: a first acquisition step that obtains a first information, which is to be used for a predetermined process in a facility, from a clothing ornament of a user who uses the facility; a second acquisition process that obtains a second information, which is to be used in an authentication process for the user, in a different path from that of the first information; an authentication process that performs the authentication process by using the second information; and a permission process that permits execution of the predetermined process using the first information, when the user can be authenticated in the authentication process.

### Advantageous Effects of Invention

According to the processing management system, the processing management apparatus, the processing management method, and the computer program in the respective example aspects described above, it is possible to suitably manage whether or not to permit the execution of the process performed in a facility.

### BRIEF DESCRIPTION OF DRAWINGS

FIG. 1 is a block diagram illustrating an entire configuration of a processing management system according to a first example embodiment.

FIG. 2 is a schematic diagram illustrating an example of a nail equipped with an RFID tag.

FIG. 3 is a block diagram illustrating a hardware configuration of a processing management apparatus according to the first example embodiment.

FIG. 4 is a flowchart illustrating a flow of operation of the processing management system according to the first example embodiment.

FIG. 5 is a block diagram illustrating an entire configuration of a processing management system according to a second example embodiment.

FIG. 6 is a flowchart illustrating a flow of operation of the processing management system according to the second example embodiment.

FIG. 7 is a diagram illustrating an example of operation when the processing management system according to the second example embodiment is applied to a theme park.

### DESCRIPTION OF EXAMPLE EMBODIMENTS

Hereinafter, a processing management system, a processing management apparatus, a processing management method, a computer program, and a recording medium will be described with reference to the drawings.

### First Example Embodiment

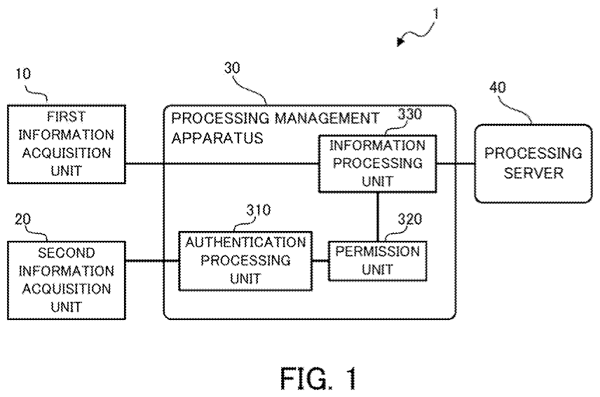

A processing management system according to a first example embodiment will be described with reference to FIG. 1 to FIG. 4.

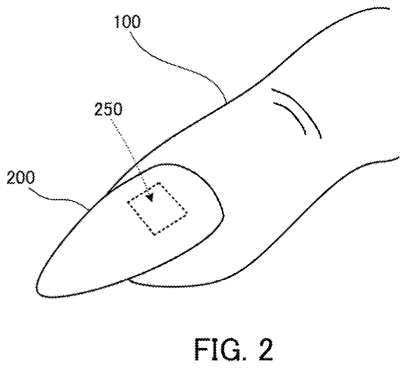

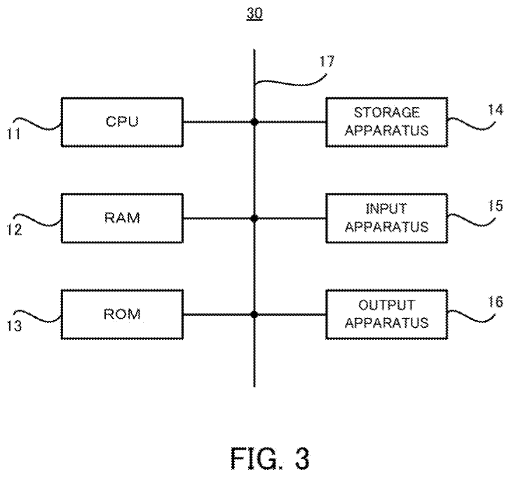

(System Configuration) Firstly, a configuration of the processing management system according to the first example embodiment will be described with reference to FIG. 1 to FIG. 3. FIG. 1 is a block diagram illustrating an entire configuration of the processing management system according to the first example embodiment. FIG. 2 is a schematic diagram illustrating an example of a nail equipped with an RFID tag. FIG. 3 is a block diagram illustrating a hardware configuration of the processing management apparatus according to the first example embodiment.

In FIG. 1, a processing management system 1 according to the first example embodiment is applied to various facilities (e.g., a theme park, a zoo, an aquarium, a museum, a stadium, a concert venue, a hotel, a station, an airport, etc.), and includes, as main components, a first information acquisition unit 10, a second information acquisition unit 20, a processing management apparatus 30, and a processing server 40. The processing management system 1 may be applied to outdoor facilities, such as, for example, an outdoor type theme park and an outdoor concert venue. That is, the “facility” to which the processing management system 1 is applied is not limited to an indoor facility, such as a building and equipment, but it is a broad concept including an outdoor facility.

The first information acquisition unit 10 is configured to obtain a first information from a user's clothing ornament. The “first information” is information used for a predetermined process described later, and is, for example, information about an entrance ticket in a facility, information about means of payment used at the time of purchase of goods, and the like. Furthermore, the first information may be information that simply identifies the use. In this case, a database in which information about the user is stored is queried about the first information (i.e., the information that identifies the user), so that it is possible to specify that the user is a user who is permitted to enter the facility, or it is possible to specify information about the user's means of payment. The “clothing ornament” is a decorative item that the user wears (in other words, a detachable decorative item), and it is a broad concept including, for example, a nail (artificial nail), a tattoo seal, and various other accessories, as well as portable small items, such as a bag and a belt. The first information acquisition unit 10 is configured to include various readers and the like, and obtains the first information from an IC tag mounted on the decorative item, various codes added to the decorative item, or the decorative item itself (e.g., shape and pattern of the decorative item, etc.). The first information acquisition unit 10 is a specific example of the “first acquisition unit” in Supplementary Note described later.

As illustrated in FIG. 2, it is assumed that a nail 200 put on the user's finger 100 is equipped with an RFID tag 250 and that the first information is stored in the RFID tag 250. In this case, the first information acquisition unit 10 may be configured as an RFID reader. The first information may be obtained by the user holding the nail 200 over the RFID reader (i.e., the first information acquisition unit 10) or may be automatically obtained when the user approaches the first information acquisition unit 10.

Back in FIG. 1, the second information acquisition unit 20 is configured to obtain a second information in a different path from that of the first information. The “second information” is information used for an authentication process (in other words, identity verification process) for the user. An example of the second information is a user's face image. In this case, the second information acquisition unit 20 is configured to include a camera for capturing the user's face image. In addition, the second information may be the user's biometric information (specifically, information about fingerprints, iris, and the like), other than the face image. Alternatively, the second information may be information about an account associated with the user. An example of the information that is about the account associated with the user and that is used in the authentication process, includes information about an authentication code included in a message transmitted from the process management system 1 for accounts of various services available to the user, such as SMS (Short Messaging Service) and SNS (Social Networking Service). In this case, the second information acquisition unit 20 obtains the information about the user's account (in this case, for example, the information about the authentication code inputted by the user) through an input apparatus to which the user can input the authentication code (e.g., a terminal (e.g., a smartphone) owned by the user or an input apparatus installed in a facility). The second information acquisition unit 20 is a specific example of the “second acquisition unit” in Supplementary Note described later.

The processing management apparatus 30 is configured, for example, as a management server, and includes an authentication processing unit 310, a permission unit 320, and an information processing unit 330 as functional blocks implemented therein.

The authentication processing unit 310 is configured to perform the authentication process by using the second information obtained by the second information acquisition unit 20. As for the specific processing contents of the authentication process, the existing technology can be appropriately employed, but, for example, when the user's face image is obtained as the second information, a face authentication process using the face image is performed. More specifically, a score indicating a degree of coincidence of the face image is calculated by comparing a feature quantity extracted from the face image with a feature quantity of the face image of the user stored in advance, and the user's identity verification is performed on the basis of the score. A result of the authentication by the authentication processing unit 310 is outputted to the permission unit 320. The authentication processing unit 310 is a specific example of the “authentication unit” in Supplementary Note described later. Alternatively, for example, when the information about the account associated with the user (e.g., the authentication code described above) is used as the second information, the authentication processing unit 310 may perform the authentication process on the basis of the authentication code obtained by the second information acquisition unit 20 from the user as the second information. Specifically, the user may be authenticated when the authentication code is inputted to the system and when the authentication code is correct. For example, if entrance to the facility is permitted after the authentication of whether or not the user is a person in question (i.e., the identity verification), if the identity verification is successfully performed, a message such as “entrance permit” is displayed on the terminal or the like owned by the user, and the entrance may be permitted by showing it to a staff. Alternatively, the entrance may be permitted by using the function of NFC (Near Field Communication) installed in the terminal owned by the user or QR code (registered trademark) or the like and by holding the terminal over a gate after the identity verification.

The permission unit 320 is configured to determine whether or not to permit the execution of a predetermined process using the first information (a process performed by the processing server 40 described later), in accordance with the authentication result of the authentication processing unit 310. Specifically, the permission unit 320 permits the execution of the predetermined process using the first information when the user is successfully authenticated by the authentication processing unit 310, but does not permit the execution of the predetermined process using the first information when the user is not successfully authenticated by the authentication processing unit 310. A result of the determination by the permission unit 320 is outputted to the information processing unit 330. The permission unit 320 is a specific example of the “permission unit” in Supplementary Note described later.

The information processing unit 330 outputs the first information obtained by the first information acquisition unit 10 to the processing server 40 in accordance with the determination result of the permission unit 320. Specifically, the information processing unit 330 outputs the first information to the processing server 40 when the execution of the predetermined process is permitted by the permission unit 320, but does not output the first information to the processing server 40 when the execution of the predetermined process is not permitted by the permission unit 320. As a result, when the execution of the predetermined process is permitted by the permission unit 320, the predetermined process using the first information is performed in the processing server 40.

As illustrated in FIG. 3, the processing management apparatus 30 according to the first example embodiment includes a CPU (Central Processing Unit) 11, a RAM (Random Access Memory) 12, a ROM (Read Only Memory) 13, a storage apparatus 14, an input apparatus 15, and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 may read a computer program stored by at least one of the RAM 12, the ROM 13 and the storage apparatus 14. For example, the CPU 11 may read a computer program stored in a computer-readable recording medium, by using a not-illustrated recording medium reading apparatus. The CPU 11 may obtain (i.e., read) a computer program from a not illustrated apparatus located outside the store management system 1, through a network interface. The CPU 11 controls the RAM 12, the storage apparatus 14, the input apparatus 15, and the output apparatus 16 by executing the read computer program. Especially in the first example embodiment, when the CPU 11 executes the read computer program, a functional block for managing whether or not to permit the execution of the predetermined process in the facility is implemented in the CPU 11. In other words, the CPU 11 is configured to function as a controller for managing whether or not to permit the execution of the predetermined process. The authentication processing unit 310, the permission unit 320, and the information processing unit 330 described above are implemented in this CPU 11, for example.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the processing management system 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the processing management system 1. The input apparatus 15 may include, for example, at least one of a keyboard, a mouse, and a touch panel.

The output apparatus 16 is an apparatus that outputs information about the processing management system 1 to the outside. For example, the output apparatus 16 may be a display apparatus that is configured to display the information about the processing management system 1.

Returning back to FIG. 1, the processing server 40 is a server that is configured to perform the predetermined process in the facility to which the processing management system 1 is applied. The “predetermined process” refers to various processes that can be performed by the system in the facility. An example of such processes includes a process of managing the entrance and exit of the facility, and a process of payment in the facility, or the like. The processing server 40 performs the predetermined process by using the first information when the first information is outputted from the information processing unit 330 of the processing management apparatus 30 (in other words, when the execution of the predetermined process is permitted in the permission unit 320).

(Explanation of Operation)

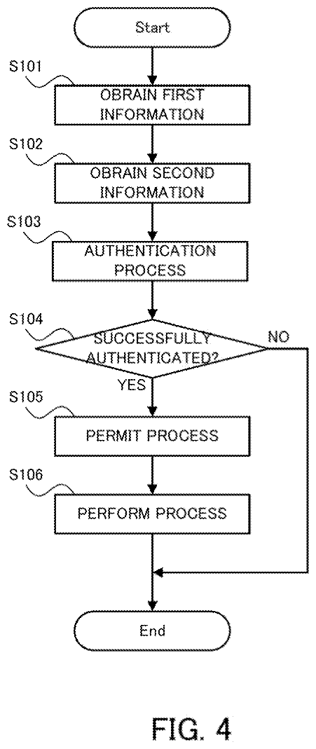

Next, with reference to FIG. 4, a flow of the operation of the processing management system 1 according to the first example embodiment will be described. FIG. 4 is a flowchart illustrating a flow of the operation of the processing management system according to the first example embodiment.

As illustrated in FIG. 4, in operation of the processing management system 1 according to the first example embodiment, the information acquisition unit 10 firstly obtains the first information from the user's clothing ornament (step S101). Furthermore, the second information acquisition unit 20 obtains the second information for authenticating the user (step S102). Incidentally, the first information and second information may be obtained concurrently, or may be obtained one after the other. Alternatively, the first information may be obtained after the execution of the predetermined process using the first information is permitted (specifically, after step S105 described later).

Subsequently, the authentication processing unit 310 performs the authentication process for the user by using the second information obtained by the second information acquisition unit 20 (step S103). When the user is successfully authenticated (the step S104: YES), the authorization unit 320 permits the execution of the predetermined process (step S105). In this case, the predetermined process is performed by the processing server 40 (step S106). On the other hand, if the user is not successfully authenticated (the step S104: NO), the authorization unit 320 does not permit the execution of the predetermined process (i.e., the step S105 is not performed). Consequently, the predetermined process by the processing server 40 is not performed (i.e., the step S106 is omitted).

(Technical Effects)

Next, technical effects obtained by the processing management system 1 according to the first example embodiment will be described.

As described in FIG. 1 to FIG. 4, according to the processing management system 1 in the first example embodiment, when the authentication process using the second information is successfully performed, the predetermined process using the first information is performed. Therefore, as compared with when the authentication processing using the second information is not performed, the security of the predetermined process can be enhanced. Specifically, it is possible to prevent an improper use of the clothing ornament in which the first information is stored (e.g., a third party who found the clothing ornament performs a process of high-value payment as the predetermined process, etc.).

Incidentally, the improvement in the security as described above reduces a risk when the user has lost the clothing ornament, as a medium for storing the first information, and makes it easy to use a detachable clothing ornament. Since the clothing ornament is excellent in portable performance, the convenience of the user can be enhanced. In addition, by making the clothing ornament fashionable, it is possible to effectively increase the user's willingness to purchase and satisfaction.

### Second Example Embodiment

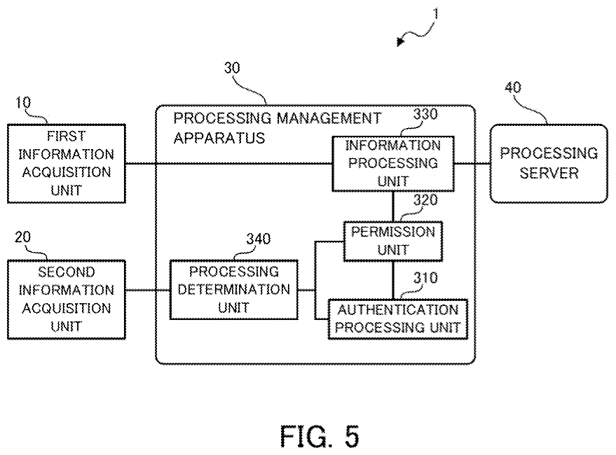

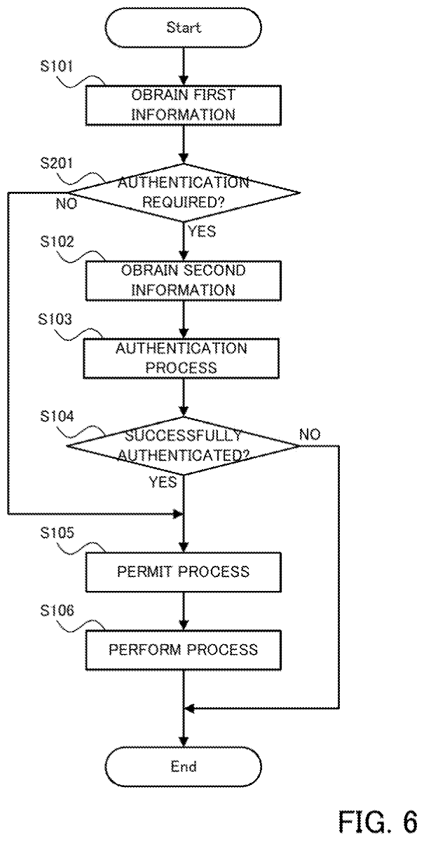

Next, the processing management system 1 according to a second example embodiment will be described with reference to FIG. 5 and FIG. 6. The second example embodiment is partially different from the first example embodiment described above in configuration and operation, and is generally the same in the other parts. Therefore, the parts that differ from those of the first example embodiment will be described in detail below, and an explanation of the other overlapping parts will be omitted as occasion demands.

(System Configuration)

Firstly, a configuration of the processing management system according to the second example embodiment will be described with reference to FIG. 5. FIG. 5 is a block diagram illustrating an entire configuration of the processing management system according to the second example embodiment. In FIG. 5, the same components as those of the processing management system 1 according to the first example embodiment illustrated in FIG. 1 carry the same reference numerals.

As illustrated in FIG. 5, in the processing management system 1 according to the second example embodiment, the processing management apparatus 30 includes a processing determination unit 340, in addition to the functional blocks (i.e., the authentication processing unit 310, the permission unit 320, and the information processing unit 330) of the first example embodiment illustrated in FIG. 1.

The processing determination unit 340 is configured to determine whether or not the predetermined process performed by the processing server 40 is a process with a high degree of importance. Here, the “high degree of importance” is a value determined in accordance with security strength required for the predetermined process; for example, low-value payment has a relatively low degree of importance, whereas high-value payment has a relatively high degree of importance. In addition, the degree of importance may be set to be high for a process of providing services with a legal age limit or the like. The degree of importance may be set in advance in accordance with processing details, or may be set by the user or the staff of the facility who understands the processing details performing a predetermined operation. A result of determination by the processing determination unit 340 is configured to be outputted to the authentication processing unit 310 or the permission unit 320. The operation at this time will be described in detail below.

(Explanation of Operation)

Next, with reference to FIG. 6, a flow of the operation of the processing management system 1 according to the second example embodiment will be described. FIG. 6 is a flowchart illustrating the flow of the operation of the processing management system according to the second example embodiment. In FIG. 6, the same process steps as those of the processing management system 1 according to the first example embodiment illustrated in FIG. 4 carry the same reference numerals.

As illustrated in FIG. 6, in operation of the processing management system 1 according to the second example embodiment, the information acquisition unit 10 firstly obtains the first information (the step S101), and then, the processing determination unit 340 determines whether or not the authentication process (specifically, the authentication process using the second information) is required for the predetermined process (step S201). Whether or not the authentication process is required for the predetermined process is determined by using the degree of importance that is set in accordance with the processing details of the predetermined process. The processing determination unit 340 stores therein, for example, a threshold for the degree of importance. The processing determination unit 340 determines that the authentication process is required when the degree of importance is higher than the threshold, and determines that the authentication process is not required when the degree of importance is lower than the threshold.

When it is determined that the authentication process is required in the processing determination unit 340 (the step S201: YES), the second information acquisition unit 20 obtains the second information (the step S102), and even after that, the same process steps as those of the first example embodiment are performed. That is, the execution of the predetermined process is permitted when the user is successfully authenticated in the authentication process, and the execution of the predetermined process is not permitted when the user is not successfully authenticated. On the other hand, when it is determined that the authentication process is not required in the processing determination unit 340 (the step S201: NO), the authentication process using the second information (i.e., the step S102 to the step S104) is omitted. As a result, without performing the authentication process, the execution of the predetermined process using the first information is permitted (the step S105). In other words, the predetermined process is performed regardless of whether or not the authentication is successful in the authentication process (the step S106).

(Technical Effects)

Next, technical effects obtained by the processing management system 1 according to the second example embodiment will be described.

As described in FIG. 5 and FIG. 6, according to the processing management system 1 in the second example embodiment, it is possible to efficiently reduce a processing load by requiring the authentication process for the process with a high degree of importance and by not requiring the authentication process for a process with a low degree of importance. Specifically, since the authentication process is not required for the process with a low degree of importance, the number of executions of the authentication process is reduced, as compared with when the authentication process is requested for all the processes, and the load on the system is accordingly reduced. Moreover, it is possible to prevent the user and the facility staff from feeling troublesome by requiring the authentication process at each time. Furthermore, in a place where there is little or no chance that the process with a high degree of importance is performed, the apparatus for obtaining the second information described above (e.g., the second information acquisition unit 20) may not be installed. Therefore, as compared with when the apparatus for obtaining the second information is installed in all the places where the process is performed, it is possible to reduce the cost of the processing management system 1.

(Specific Operation Example)

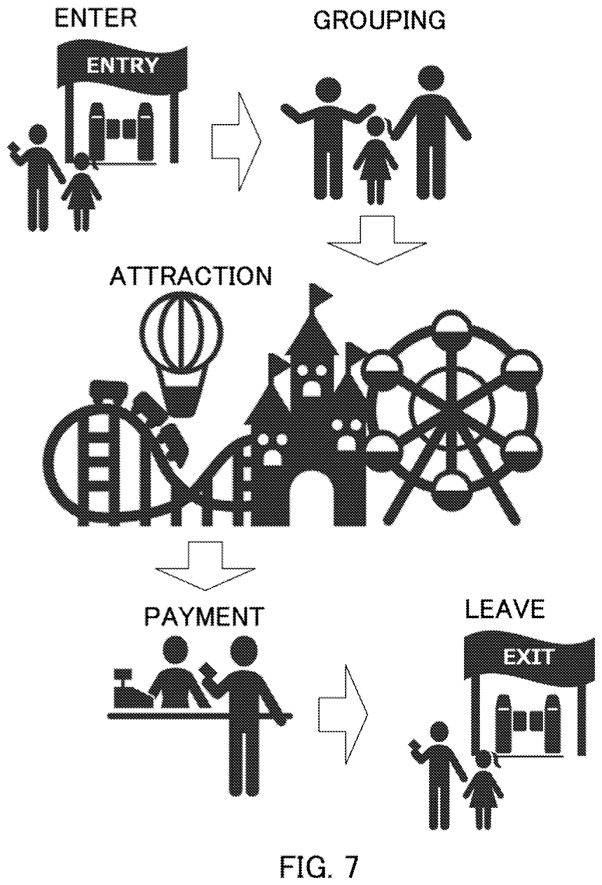

Next, with reference to FIG. 7, a specific description will be given to an operation example when the processing management system 1 according to the second example embodiment described above is applied to a theme park. FIG. 7 is a diagram illustrating the operation example when the processing management system according to the second example embodiment is applied to the theme park. In the example described below, it is assumed that the first information is stored in the user's nail and that the second information is obtained as the face image.

As illustrated in FIG. 5, the processing management system 1 according to the second example embodiment is configured to perform at least one of a plurality of types of processes performed in the theme park as the predetermined process. The user purchases the nail in which the first information is stored, before entering the theme park. Alternatively, the user may purchase the nail in which the first information is stored, at a ticket shop installed near an entrance gate of the theme park, or the like. At that time, the user registers his or her own personal information (e.g., name, address, telephone number, email address, credit card information, etc.). These information (i.e., personal information) may be stored, for example, in the nail as the first information, or may be stored in the processing management system 1. Incidentally, various designs are prepared for the nail, which is a storage medium of the first information, and the user can purchase the nail in a favorite design from among them. Enhancing the nail's fashionability makes it possible to increase the user's willingness to purchase even if the cost of purchasing the nail (i.e., introduction cost) becomes somewhat higher.

When the user visits the theme park, the process management system 1 may firstly perform an entrance process to the theme park as the predetermined process. Here, it is assumed that the entrance process to the theme park is a process with a relatively high degree of importance (in other words, a process in which the authentication process is required). In this case, the user holds the nail over a reader installed near the entrance gate of the theme park, and allows the reader to read an entrance ticket information stored as the first information. Alternatively, the information that identifies the user stored as the first information may be used to confirm whether or not to be the user authorized to enter the theme park. Furthermore, the user's face image, which is the second information, is also obtained by a camera installed near the entrance gate. The processing management system 1 then authenticates the user through face authentication using the face image. When the face authentication is successfully performed, the processing server 40 performs the user's entrance process by using the entrance ticket information obtained as the first information. In the entrance process, it is confirmed whether or not the entrance ticket information is effective, to permit the user to enter the theme park. When the user is permitted to enter, the following processes may be performed; for example, the entrance gate may be automatically opened or closed, or the staff at the entrance gate may be informed that the user has an effective entrance ticket.

Then, the processing management system 1 may perform a grouping process as the predetermined process. Here, it is assumed that the grouping process is a process with a relatively low degree of importance (in other words, a process in which the authentication process is not required). The grouping process is a process for associating a plurality of users as a single group, and is performed, for example, for family members or couples. The grouping process is typically performed simultaneously with the entrance process described above. In the grouping process, a group information stored as the first information (e.g., information about a companion inputted at the purchase of the ticket) is used to perform the grouping. A plurality of users grouped are associated with each other, so that it is possible to perform a process to find other group users, for example, when someone gets lost or separated from the others. In this case, it is preferable that the nail is equipped with a GPS (Global Positioning System) for obtaining a position information. Furthermore, by associating a terminal owned by the user (e.g., a mobile phone or a smartphone) with the nail, it is also possible to obtain the position information from the GPS of the terminal. Alternatively, in addition to or in place of the installation of the GPS, when a plurality of predetermined terminals for reading the first information from the nail are installed in the theme park, the user's position (or moving path) may be estimated on the basis of a result of the reading of the first information by the predetermined terminal. Incidentally, a process for searching for the other group users can also be performed as the predetermined process using the group information stored as the first information. Specifically, when the separated user holds the nail over the predetermined terminal, the following processes may be performed as the predetermined process; for example, the positions of the other group users may be displayed on a display, or the position of the separated user may be transmitted to the other group users (e.g., an email indicating the position may be transmitted to the other users).

Next, the processing management system 1 may perform an attraction use process (i.e., a process of determining whether or not the user has the right to use an attraction) as the predetermined process. Here, it is assumed that the attraction use process is a process with a relatively low degree of importance (in other words, a process in which the authentication process is not required). In this case, the user holds the nail over a reader installed near an entrance gate of the attraction, and allows the reader to read an information about a ticket for using the attraction stored as the first information. After that, the processing server 40 performs the user's attraction use process, by using the information about the ticket for using the attraction obtained as the first information, without performing the authentication process using the second information. In the attraction use process, it is confirmed whether or not the information about the ticket for using the attraction is effective, to permit the user to use the attraction. When the use of the attraction is permitted, the following processes may be performed; for example, the entrance gate of the attraction is automatically opened or closed, or the staff of the attraction may be informed that the user has an effective ticket for use. It is also conceivable to manage the ticket for use by using an electronic device such as a portable information terminal, or a paper medium; however, there is a possibility that the ticket for use may be damaged during the use of an attraction that shakes violently or that gets wet with water, and may be no longer managed. However, by managing the ticket for use by using the clothing ornament, such as the nail, which is resistant to water, dirt, and impact, and which is to always put on the body, it is possible to reduce the possibility that the ticket for use may be no longer managed even if the user rides on the attraction that shakes violently or that gets wet with water.

Furthermore, a fastpass information about the attraction (i.e., information indicating that the attraction can be preferentially used) may be stored as the first information. If the clothing ornament stores the first information as rewritable information, the fastpass information can be added later without purchasing a fastpass before entering the theme park (i.e., the fastpass can be additionally purchased after the entrance). Furthermore, when the first information is rewritable, a process of collecting points (e.g., a process of managing a system in which points are collected in accordance with the number of uses of the attraction and the number of purchases of goods) can also be performed as the predetermined process. In addition, when the first information is rewritable, it is also possible to prohibit the use of the already used fastpass or ticket for use (or it is possible to delete the information about the fastpass or ticket for use).

In addition to the use of the attraction, information for participating in various events to be held in the theme park may be stored as the first information. An example of the events includes a show held in the theme park, a photo session with a character, a smile contest in which photos are posted to compete for smiles, and the like. By having the user participate in the event for photographing, it is possible to increase opportunities for the processing management system 1 to obtain the user's face image (especially, opportunities for obtaining an image in which the user's face is clearly captured). Therefore, it is also possible to obtain an effect that authentication accuracy is improved when the face image is used as the second information (i.e., when the face authentication process is performed as the authentication process). Furthermore, the right to participate in such events may be given as a benefit to the user who uses the processing management system 1 according to the second example embodiment. That is, the right to participate in the events may be granted as a benefit to the user who uses not a normal ticket (e.g., a paper ticket) but the nail as the ticket or the like. Thus, it is possible to effectively increase the number of the users who use the nail as the ticket or the like (in other words, the number of the users who use the processing management system 1). In the case of a regular paper ticket, the user possibly puts the ticket that is not being used into a bag or the like, but in the case of the nail, it is always kept visible from the outside. Thus, for example, the staff of the theme park can also easily visually recognize a purchaser of the nail, and can easily provide the benefits (e.g., a special performance only for the nail purchaser, etc.).

Next, the processing management system 1 may perform a payment process in the theme park as the predetermined process (e.g., a payment process when purchasing food and beverages, souvenirs, etc.). Here, it is assumed that the payment process is a process in which the degree of importance is determined according to the amount of payment. For example, it is assumed that the payment process is a process with a relatively low degree of importance (in other words, a process in which the authentication process is not required) when the amount of payment is less than or equal to 10000 yen, and that the payment process is a process with a relatively high degree of importance (in other words, a process in which the authentication process is required) when the amount of payment is greater than 10000 yen. In this case, the user holds the nail over a reader installed near a casher and allows the reader to read a payment information (e.g., a credit card information or an electronic money information) stored as the first information. After that, the processing management system 1 determines whether or not to perform the authentication process in accordance with the amount of payment. When it is determined that the authentication process is not required, the processing server 40 performs the payment process. On the other hand, when it is determined that the authentication process is required, the user's face image, which is the second information, is obtained by a camera installed near the casher, and the user is authenticated by the face authentication using the face image. When the face authentication is successfully performed, the processing server 40 performs the payment process by using the payment information obtained as the first information. Such a payment process is also applicable to unmanned stores.

Finally, the processing management system 1 may perform a leaving process from the theme park as the predetermined process. Here, it is assumed that the leaving process from the theme park is a process with a relatively low degree of importance (in other words, a process in which the authentication process is not required). In this case, the user holds the nail over the reader installed near the entrance gate of the theme park, and allows the reader to read the entrance ticket information stored as the first information. After that, the processing server 40 performs the user's leaving process by using the entrance ticket information obtained as the first information. In the leaving process, the user's exit from the theme park is recorded. At this time, a process of deleting the first information about the use of the theme park (e.g., the entrance ticket information, the information about the ticket for using the attraction, etc.) from the user's clothing ornament may be performed. Furthermore, a process of deleting the user's personal information or the like held by the processing management system 1 may be performed. In addition, when a valid period (i.e., a time length in which the theme park can be used) is set in the entrance ticket and if the user's leaving time has passed the valid period, then, a process of collecting an additional charge may be performed.

The user can continue to use the nail after leaving the theme park. In other words, the nail can be used not only as the ticket or the like in the theme park, but also can be used as a fashion item outside the theme park. In the case of nail, for example, it may be unusable after a few days, but if a more durable clothing ornament is used, the user can continue to use it as a fashion item for a long period of time.

As described above, the processing management system 1 according to the second example embodiment is configured to manage the execution of various processes in the theme park by using the first information stored in the nail and the second information obtained as the user's face image. According to such a system, the user can use the theme park, more conveniently, while enjoying the nail as a fashion. In addition, by managing a plurality of types of processes in the theme park, the processing management system 1 is also allowed to grasp the position of the user and the behavior of the user in the theme park. Specifically, it is possible to know in what order the user use the attractions or what the user purchase, from when the user enters the theme park to when the user leaves. Such information can be used for user behavior pattern analysis (e.g., analysis of the moving path, analysis of the user's willingness to purchase, etc.).

Furthermore, the processing management system 1 may be configured to manage the predetermined process not only at one facility but also at a plurality of facilities. For example, when managing the process in the theme park, the processing management system 1 may be configured to manage the predetermined process at other facilities located around the theme park (e.g., a check-in process at a hotel adjacent to the theme park, or a ticket inspection process at the nearest station to the theme park, etc.).

<Supplementary Notes>

With respect to the example embodiments described above, the following Supplementary Notes will be further disclosed.

(Supplementary Note 1)

A processing management system described in Supplementary Note 1 is a processing management system including: a first acquisition unit that obtains a first information, which is to be used for a predetermined process in a facility, from a clothing ornament of a user who uses the facility; a second acquisition unit that obtains a second information, which is to be used in an authentication process for the user, in a different path from that of the first information; an authentication unit that performs the authentication process by using the second information; and a permission unit that permits execution of the predetermined process using the first information, when the user can be authenticated in the authentication process.

(Supplementary Note 2)

A processing management system described in Supplementary Note 2 is the processing management system described in Supplementary Note 1, wherein the second acquisition unit obtains a biometric information on the user as the second information.

(Supplementary Note 3)

A processing management system described in Supplementary Note 3 is the processing management system described in Supplementary Note 2, wherein the second acquisition unit obtains a face image of the user as the second information, and the authentication unit performs face authentication using the face image as the authentication process.

(Supplementary Note 4)

A processing management system described in Supplementary Note 4 is the processing management system described in Supplementary Note 1, wherein the second acquisition unit obtains information about an account associated with the user as the second information.

(Supplementary Note 5)

a processing management system described in Supplementary Note 5 is the processing management system described in any one of Supplementary Notes 1 to 4, wherein a degree of importance according to processing details is set for the predetermined process, and the permission unit (i) permits the execution of the predetermined process in which the degree of importance is greater than or equal to a predetermined threshold when the user can be authenticated by the authentication process, and (ii) permits the execution of the predetermined process in which the degree of importance is less than the predetermined threshold, regardless of whether or not the user can be authenticated by the authentication process.

(Supplementary Note 6)

A processing management system described in Supplementary Note 6 is the processing management system described in Supplementary Note 5, wherein the predetermined process is a payment process in the facility, and the degree of importance is set in accordance with amount of payment in the payment process.

(Supplementary Note 7)

A processing management system described in Supplementary Note 7 is the processing management system described in any one of Supplementary Notes 1 to 6, wherein the first information is stored in the user's clothing ornament in a rewritable state.

(Supplementary Note 8)

A processing management apparatus described in Supplementary Note 8 is a processing management apparatus that is configured to determine whether or not to permit execution of a predetermined process in a facility using a first information, which is obtained from a clothing ornament of a user who uses the facility, the processing management apparatus including: an authentication unit that performs an authentication process for the user, by using a second information, which is obtained in a different path from that of the first information; and a permission unit that permits the execution of the predetermined process using the first information, when the user can be authenticated by the authentication unit.

(Supplementary Note 9)

A processing management method described in Supplementary Note 9 is a processing management method including: a first acquisition step that obtains a first information, which is to be used for a predetermined process in a facility, from a clothing ornament of a user who uses the facility; a second acquisition process that obtains a second information, which is to be used in an authentication process for the user, in a different path from that of the first information; an authentication process that performs the authentication process by using the second information; and a permission process that permits execution of the predetermined process using the first information, when the user can be authenticated in the authentication process.

(Supplementary Note 10)

A computer program described in Supplementary Note 10 is a computer program that allows a computer to execute: a first acquisition step that obtains a first information, which is to be used for a predetermined process in a facility, from a clothing ornament of a user who uses the facility; a second acquisition process that obtains a second information, which is to be used in an authentication process for the user, in a different path from that of the first information; an authentication process that performs the authentication process by using the second information; and a permission process that permits execution of the predetermined process using the first information, when the user can be authenticated in the authentication process.

(Supplementary Note 11)

A recording medium described in Supplementary Note 11 is a recording medium on which a computer program described in Supplementary Note 10 is recorded.

The present invention is not limited to the examples described above and is allowed to be changed, if desired, without departing from the essence or spirit of the invention which can be read from the claims and the entire specification. A processing management system, a processing management apparatus, a processing management method, and a computer program with such changes are also intended to be within the technical scope of the present invention.

### DESCRIPTION OF REFERENCE CODES

1 Processing management system
10 First information acquisition unit
20 Second information acquisition unit
30 Processing management apparatus
40 Processing server
100 Finger
200 Nail
250 RFID tag
310 Authentication processing unit
320 Permission unit
330 Information processing unit
340 Processing determination unit

What is claimed is:

1. A processing management system comprising:
at least one memory configured to store instructions; and
at least one processor configured to execute the instructions to:
obtain a first information, which is to be used for a predetermined process in a facility, from a clothing ornament of a user who uses the facility;
obtain a second information, which is to be used in an authentication process for the user, in a different path from that of the first information;
perform the authentication process by using the second information; and
permit execution of the predetermined process using the first information, when the user can be authenticated in the authentication process.

2. The processing management system according to claim 1, wherein the at least one processor is configured to execute the instructions to obtain a biometric information on the user as the second information.

3. The processing management system according to claim 2, wherein the at least one processor is configured to execute the instructions to:
obtain a face image of the user as the second information, and
perform face authentication using the face image as the authentication process.

4. The processing management system according to claim 1, wherein the at least one processor is configured to execute the instructions to obtain information about an account associated with the user as the second information.

5. The processing management system according to claim 1, wherein
a degree of importance according to processing details is set for the predetermined process, and
the at least one processor is configured to execute the instructions to (i) permit the execution of the predetermined process in which the degree of importance is greater than or equal to a predetermined threshold when the user can be authenticated by the authentication process, and (ii) permit the execution of the predetermined process in which the degree of importance is less than the predetermined threshold, regardless of whether or not the user can be authenticated by the authentication process.

6. The processing management system according to claim 5, wherein
the predetermined process is a payment process in the facility, and
the degree of importance is set in accordance with amount of payment in the payment process.

7. The processing management system according to claim 1, wherein the first information is stored in the user's clothing ornament in a rewritable state.

8. (canceled)

9. A processing management method comprising:
obtaining a first information, which is to be used for a predetermined process in a facility, from a clothing ornament of a user who uses the facility;
obtaining a second information, which is to be used in an authentication process for the user, in a different path from that of the first information;
performing the authentication process by using the second information; and
permitting execution of the predetermined process using the first information, when the user can be authenticated in the authentication process.

10. A non-transitory program recording medium on which a computer program that allows a computer to execute a processing management method is recorded,
the processing management method including:
obtaining a first information, which is to be used for a predetermined process in a facility, from a clothing ornament of a user who uses the facility;
obtaining a second information, which is to be used in an authentication process for the user, in a different path from that of the first information;
performing the authentication process by using the second information; and
permitting execution of the predetermined process using the first information, when the user can be authenticated in the authentication process.
